(19) United States
(12) Patent Application Publication
(10) Pub. No.: US 2003/0023459 A1
(43) Pub. Date: Jan. 30, 2003

(54) System and method for audio-visual one-on-one realtime supervision

(76) Inventor: Jacob A. Shipon, Rydal, PA (US)

Correspondence Address: OBERMAYER REBMANN MAXWELL & HIPPEL LLP, 1617 JOHN F KENNEDY BLVD, 19TH FLOOR, PHILIDELPHIA, PA, 19103, US

(21) Appl. No.: 10/096,524

(22) Filed: Mar. 11, 2002

Related U.S. Application Data
(60) Provisional application No. 60/274,529, filed on Mar. 9, 2001.

(51) Int. Cl. G06F 17/60

(52) U.S. Cl. 705/2

(57) ABSTRACT

A method for providing an end user and/or supervision provider with the information and real time access relevant to an area of interest comprising the following steps: (a) providing a web based channeled network site or sites comprising a presentation whereby the end user and/or provider can select various options related to the area of interest; (b) providing an interface whereby the end user can directly interface in real time with a professional end user; and (c) facilitating the payment by the end user for a service to be provided by the professional end user.

### CLAIM OF PRIORITY

This application derives priority from U.S. Serial No. 60/274,529 filed Mar. 9, 2001.

### FIELD OF THE INVENTION

The present invention is directed to the field of providing information related to medicine, law, engineering or any other area of interest via a global computer network. In particular, the present invention is directed to a system for providing and facilitating the transfer of audio-visual, multimedia and other information between end users, such as medical related information, via a global computer network.

### BACKGROUND OF THE INVENTION

The present invention is directed to a global audiovisual network application for controlling the flow of information between, for example, a medical professional and a patient. The present invention is similarly applicable to any environment in which various types of information, including textual, graphical, audio and visual can be shared or transferred between end users.

Recent research has established that the health care industry will achieve approximately $370 billion in online transactions by 2004, according to a report from Forrester Research. This report, entitled “Sizing Health Care E-Commerce”, predicts that the Internet will become the foundation for a new health care industry infrastructure supporting complex, multiparty transactions among consumers, providers, insurers and medical suppliers. With 31% of online consumers already shopping for health care products on the web, online health sales and usage show no sign of slowing. There has already been a well documented growth and proliferation of online websites and medical related portals of which WebMD.com and DRKoop.com are merely exemplary.

Further, “Cyber Citizen Health”, an ongoing program of research conducted by Cyber Dialogue, recently published a study indicating that 22.3% of all adults online rely on the Internet for health information. This study also found that 18% of adults are inclined to purchase over-the-counter drugs online; 23% to purchase vitamins and supplements online; and 20% to purchase other medical supplies online.

Similarly, a recent Healtheon Corp Internet survey of medicine revealed that 85% of physicians surveyed are currently using the Internet, a marked increase of regular online activity by physicians. This survey chronicled the computer needs and expectations of almost 10,000 physicians. The survey found that more than 63 percent of the physicians surveyed use e-mail daily and 33 percent have used e-mail to communicate with patients.

Doctor-patient communication via e-mail has jumped 200 percent in the last twelve months and nearly 20 percent in the last three months. Electronic communications between patients and doctors was statistically insignificant when physicians were first surveyed in 1997.

There have been several patents which relate to the electric distribution of medical related information. U.S. Pat. No. 5, 434,611 is directed to a home health care system that employs a two-way community antenna television network to permit remote communication between doctors and patients.

Similarly, U.S. Pat. No. 5,619,991 is directed to a system that facilitates the delivery of medical services using electronic data transmission. Finally, U.S. Pat. No. 5,748,907 discloses an interactive real-time medical management system that controls all aspects of a medical practice.

Moreover, U.S. Pat. No. 5,987,510 is directed to a packet-based telemedicine system for communicating video, voice and medical data between a central monitoring station and a patient monitoring station. The patient monitoring station obtains digital video, voice and medical measurement data from a patient and encapsulates the data in packets and sends the packets over a network to the central monitoring station. Since the information is encapsulated in packets, the information can be sent over multiple types or combinations of network architectures: the video, voice and measurement data can be integrated and sent over a single network.

Similarly, U.S. Pat. No. 5,441,047 discloses an ambulatory patient health monitoring system for monitoring a remotely-located healthcare patient from a central station. The system includes instruments for measuring parameters of the medical condition of the patient, such as heart rate, respiratory rate, pulse oximetry and blood pressure. The system includes a first audiovisual camera disposed at the patient location and a second audio-visual camera disposed at the central station. Audio and video information is transmitted between the patient's remote location and the central station via a communications network. But the system is not “network-independent” because the data must be formatted in accordance with a different communications protocol for each of these different networks. One of the disadvantages of the system disclosed in the David et al. patent is that, although it refers to sending the information between the healthcare worker and the patient via various types of networks, the information sent from the patient's home will have to be formatted Another disadvantage of the system is that the audio and video data are sent over one communications network and the patient data is sent over another communications network.

U.S. Pat. No. 5,924,074 discloses streaming compressed digital hypervideo received upon a digital communications network is decoded (decompressed) and played in a client-computer-based “video on web VCR” software system. Scene changes, if not previously marked upstream, are automatically detected, and typically twenty-one past scenes are displayed as thumbnail images. Hyperlinks within the main video scene, and/or any thumbnail image, show as hotspots, with text annotations typically appearing upon a cursor “mouse over”.

While there has been a steady growth and proliferation of medical related websites and information portals, there are a number of perceived deficiencies in the current state of the art and market offerings.

Specifically, there is a long-felt need for Internet web sites, portals and technologies which facilitate the provision of medical advice and information via a network, including real time interactive video and multimedia presentations. In particular, there is a long felt need for systems for providing such information via a plurality of platforms including the wireless web such that end users can engage in an interactive exchange of information with health professionals. There is a particular need for systems which facilitate physician oversight and interaction with the patent. Because one of the recurring problems in health care is that over 50% of patients fail to comply with recommendations made by their physicians, there is thus a long felt need for solutions which maintain closer interaction and monitoring between doctor and patient and which enable patients to maintain their own confidential patient records and to have their risk assessments annually updated and which provide real time one-on-one management.

The principal object of the present invention, therefore, is to provide, in one embodiment, a system for facilitating and providing a global audio visual network application which supports online sessions between two users, such as a physician and patient, but whose teachings are applicable to a myriad of other applications such as a lawyer/client, teacher/student, accountant/client and the like. The teachings of the present invention are thus expandable to financial services, psychiatry and the treatment of military veterans.

It is a further object of the present invention to facilitate on-line communications and user sessions in, for example the healthcare area, which will enable real time audio/visual and multimedia sessions and examinations between doctors and patients and which will facilitate reduced healthcare costs and record keeping, and which will serve the interests of prevention as well as clinical, diagnostic and administrative needs.

It is a further object of the present invention to provide a system, which when used in a medical or health care venue, maximizes user functionality, decreases office visits, decreases hospitalizations, and increases the scope and quality of services.

It is still a further object of the present invention to provide a system that facilitates the provision of health and wellness service to rural and difficult to reach venues such as to rural areas, the elderly, and the indigent.

These and other objects of the present invention will become apparent from the following detailed description and claims.

### SUMMARY OF THE INVENTION

The present invention, is in one embodiment directed to a system for providing two-way internet network access to medical information but is equally applicable to such diverse areas as psychiatry, corporate information, law, government, entertainment, fitness, elder care and educational information. The invention utilizes and incorporates a host of technologies including broad bandwidth, network resources, optimized routing and negotiated transport, two way voice-recognition, audio/visual real-time one on one supervision, data analysis and data intelligence, real time patient vital sign recording and clinical testing, on-line examination, compliance, prevention, evaluation and diagnosis, personalized content and clinical treatment in a secure on line Internet, Internet II, channeled delivery network utilizing telecommunications, fiber, satellite, television, cable and wireless technologies.

The present invention provides an easy to use mechanism for medical care patients, not only to obtain information, but also, for practitioners to provide one on one care. The invention can be utilized as part of a contracted time based, usage subscription service in which utilization of bandwidth and time forms the basis for revenue generation adjusted for medical coverage parameters.

A critical feature of the invention is the provision of one on one real time audio visual interactive patient or individual and provider or other person providing and/or enabling and facilitating supervision including voice, image and remote online and wireless inquiry, statement, examination, instruction, education, training, vital sign, other medical, knowledge tests and markers, within a proprietary secure integrated multichannel, multi-portal network individualized to patient, individual, provider, supervisor with customized and integrated connectivity design, engineering, networking, and software providing seamless intelligent software controlled access to and from multiple high bandwidth delivery mechanisms and devices.

The invention is designed to promote active participation among all levels of the healthcare industry including patients, physicians, providers (insurance companies and managed care companies), rehabilitation and exercise facilities, and government agencies involved in total patient well-being.

In the medical context, for example, the present invention provides for the interactive exchange of patient data, vitals and status in real time.

The present invention incorporates a core which has been created to extend multichannel one-on-one remote supervision for many industries. One of the most closely envisioned applications is Telemedicine and collaborative healthcare, for remote consultation and monitoring of patients.

The invention utilizes the connectivity between high bandwidth providers to form a cyber superhighway that will enable one-to-one audio/visual real-time supervision to facilitate connectivity to channel content [information technology and e-commerce functionality] into a unified platform, customized for specific target multi-industry applications.

The invention further utilizes the connectivity for any content, e-commerce portal by means of a centralized plug in capability to mold information technology, and ecommerce providers into a verified backbone in a simultaneous One on One real-time supervision environment.

The invention enables a cyber superhighway based portal to function as a backbone template, which enables high bandwidth technology companies, information technology companies, and commerce companies to maximize their valuation. In effect, the invention will be a facilitator to enable companies to utilize the basic core, which is essentially audio/visual one-to-one real-time supervision on the Internet or private network.

A principal focus of the present invention is the health care industry. The present invention provides core functionality including supervision comprising live one-to-one audio/video supervision. The invention further provides records and a history associated to that particular interaction. In the case of medical supervision, electronic medical records (EMRs) showing charts, doctors' notes, pre-stored audio/video streams, etc.

The invention includes a diagnostic alerting system, along with medical instrumentation. The invention ensures that all tests on devices will be in real-time, will be stored and will have an audio/video capability. An action may be interfaced with partnering companies, In the case of medical supervision, the channel may be labeled “E-health” and “Treatment”, bringing audio/video capability between doctors and pharmacists, for products sales, and services (dietitians, therapists ate.). Administrative functions, such as billing and auditing, accounting, interface with insurers which themselves interface with customers.

It is to be noted that the invention provides for multiple channel supervision environments. In one embodiment, five different information streams (audio/video or virtual electronic records channels) are simultaneously available to the physician during supervision procedures. The invention provides for selectability of audio video channels, in response to patient, user, institutional addresses, who accesses concurrently records, charts, history, etc. A faster channel provides supervision and contains the audio/video streams necessary for live one-on-one supervision activities, such as those involved in telemedicine applications.

The second channel provides records and contains personal information of the patient (electronic medical records, EMRs) such as charts, doctors' notes, portion of audio/video sessions, etc. The third channel, channel 3 provides diagnostics and, refers to specific real-time alert signals generated from tests run on medical instrumentation results, compared to records information and audio/visual streams. Channel 4 provides “E-health” or “Treatment”, and automatically generates prescriptions and presents them to the doctor for review and addition of his electronic signature. It also interfaces with pharmacies, and allows patients access to information about their treatments.

Finally, a fifth channel, Channel 5 comprises, the administrative and other management functions needed for each application, such as patient billing and insurance filing and purchasing. Purchasing is another feature of the administrative channel, where inventories are matched to patients needs, and orders are automatically generated when necessary. Interfaces with hospital administrative systems will be transparent to the user.

It is to be noted that that the administrative channel scenario involves prescribing as a service. A Palm-like or hand-held device may support a cellular phone and WLAN connections to the system and the patient. In an example, a doctor may write a prescription. The system will automatically send it for pre-authorization to his insurance company. The patient will pay his normal co-payment to the insurance company. The “Palm” like device may be used by the doctor's stuff to update the patient's electronic medical records in real time.

The invention's structuring allows for partnering technologies and links to Insurance companies which guarantee electronic filing and for faster insurance reimbursement to the physician.

### BRIEF DESCRIPTION OF THE FIGURES

FIG. 1 is a block diagram of a media broadcast set up for use with the present invention.

FIG. 2 is a block diagram of a prospective end user system in accordance in the present invention.

FIGS. 3 to 5 comprise block diagrams of a system in accordance with the present invention.

FIG. 6 is a block diagram of a network backbone in accordance with the present invention.

FIG. 7 is a diagram of the improved system in accordance with the present invention.

FIG. 8 is a block diagram of a further embodiment in accordance with the present invention.

Detailed Description of the Present Invention

The present invention is specifically directed to a system for providing online, interactive content and audio/video presentations and systems between at least two end users. In one embodiment, the end users may comprise a doctor and patient. In other embodiments, the end users can comprise an attorney-client, real estate broker-customer, or any other pair of commercial users who need to provide content and information to each other. Thus, while the present invention is being described in the context of the provision of medical information and care, it is to be appreciated that the present invention is applicable to a wide array of markets and applications.

In a first embodiment, the present invention comprises a dynamic content driven web application. The preferred embodiment comprising an Internet web application provides a plurality of content including searchable information, FAQs, articles, chatrooms and the ability to engage on one-on-one real time sessions between a professional end user and patient 16, 18. The patient may be bed-ridden or be in a nursing home accessible via a computer or TV module. The invention will incorporate voice recognition technology to permit both physicians and patients to input innovation and data into the system. A critical feature of the present invention is the provision of online monitoring and examination between physicians and patients. Specifically, the present invention provides for and facilitates one-on-one real time supervision between a physician and patient. The content provided is searchable by key word or phrase. This allows end users to quickly locate information within the system, which relates to a specific area of interest or need. By utilizing a database-driven system, a user is able to quickly locate information on a desired basis.

The present invention has a number of uses and applications, including the ability to “push” updated information to users; to send e-mail notices, to enable users to continue to use the programs available from the site when “offline”; to provide content and audio video formats; to enable end users to track their own progress when using program; to receive dynamic risk assessments and to locate health-care services and providers.

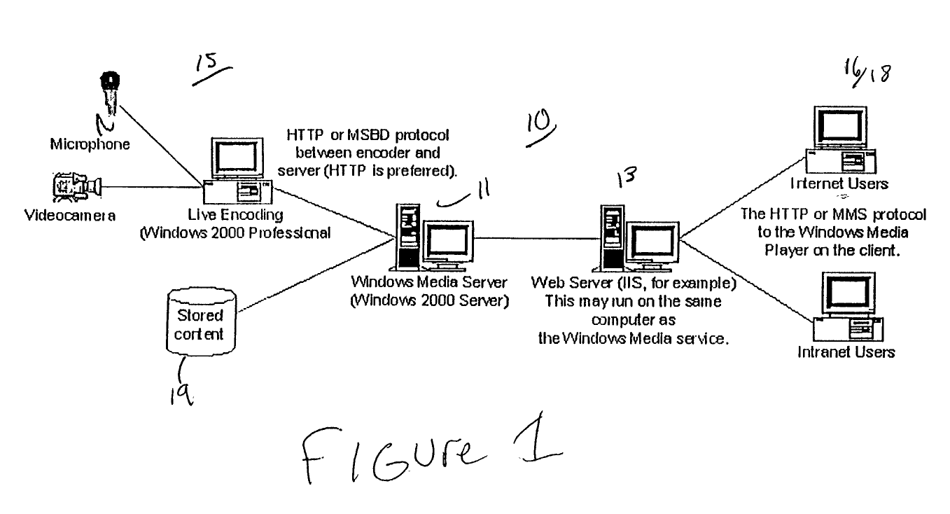

Referring to FIG. 1, a proposed diagram of the system utilized in the present invention is shown. As shown, the system comprises two dedicated servers 11, 13, a Microsoft Media and Real Media Server 10. The system further incorporates video processing software such as videoconference software applications, and for storage, databases integrated to streaming video systems based on solutions of the kind of the Real Networks' Digital Media Solutions products family. These systems should support Universal Media Delivery; Modular architectures; Standards-based solutions supporting RTSP, SMIL, XMCL, MPEG and major operating systems. The system should be able to deliver rich media via Internet-enabled devices.

The proposed site will incorporate large data storage 19 and security for medically sensitive information and the information may need to be accessed by various types of users.

The present invention is thus specifically directed to a comprehensive system for facilitating the provision of medical and health related information, including real time audio video one-on-one interaction between an end user patient and a health care professional. It is to be appreciated that the teachings of the present invention are applicable to any field of endeavor where information is shared among end users. Non-exclusive examples include the legal, financial services, banking, accounting and engineering fields. It is to be appreciated that the teachings of the present invention are thus applicable to other fields of use and areas in which information need to be shared and conveyed by and among end users. The present invention can provide selectable audio/visual channels, diagnostic information and data, news, clinical information in a wide array of medical areas, training, education and eldercare.

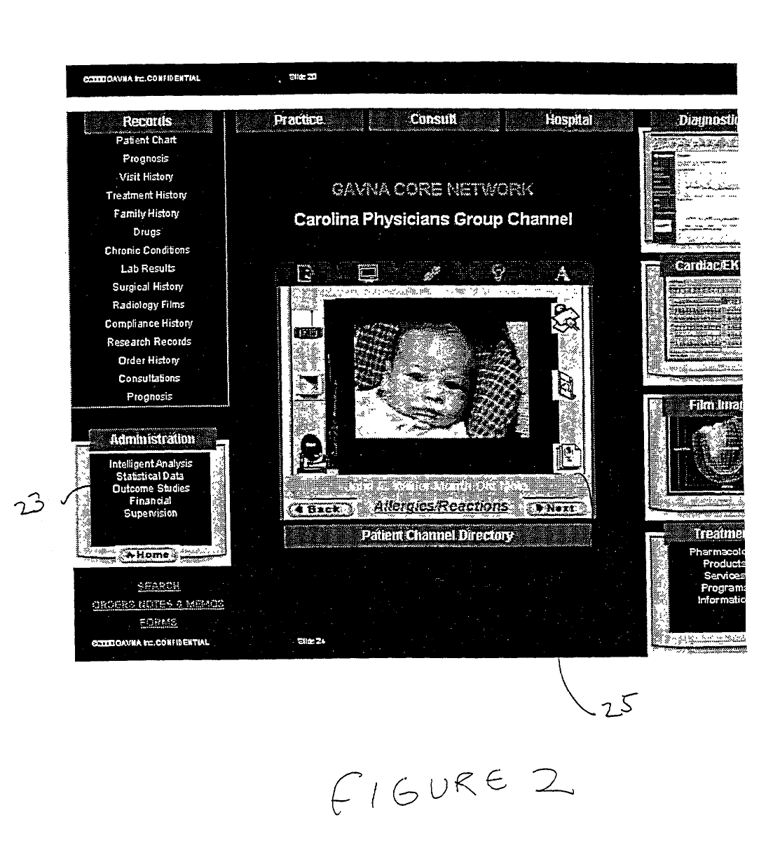

Referring now to FIG. 2, a comprehensive interactive system in accordance with the present invention is now shown and disclosed. As shown, the system comprises a system 10 for providing real time one on one communication and interaction. This provides, in one embodiment, a module 13 which records patient history, prognosis, visit history, treatment history, family history, drugs, chronic conditions, lab results, surgical history, radiology films, compliance history, research records, oral history, consultations, prognosis The system also incorporates an administration module 23 which provides intelligent analysis, statistical data, outcome studies, financial data and supervision. The system stores and displays records of consultations, hospital records, diagnostics, EKGs and film images. The system also displays the patient's treatment regimen including pharmacology, products, services, programs and information.

The central image 25, which is accessed by the physician, discloses information about the patient such as allergies and reactions. The system thus creates one on one real time audio visual interaction between patient and provider and enables and facilitates supervision including voice, image and remote online & wireless inquiry, examination, instruction, education, training, vital sign, other medical, knowledge tests and markers, within a secure integrated multi-channel, multi-portal network individualized to patient, individual, provider, supervisor with customized and integrated connectivity design, engineering, networking, and software providing seamless intelligent software controlled access to and from multiple high bandwidth delivery mechanisms and devices.

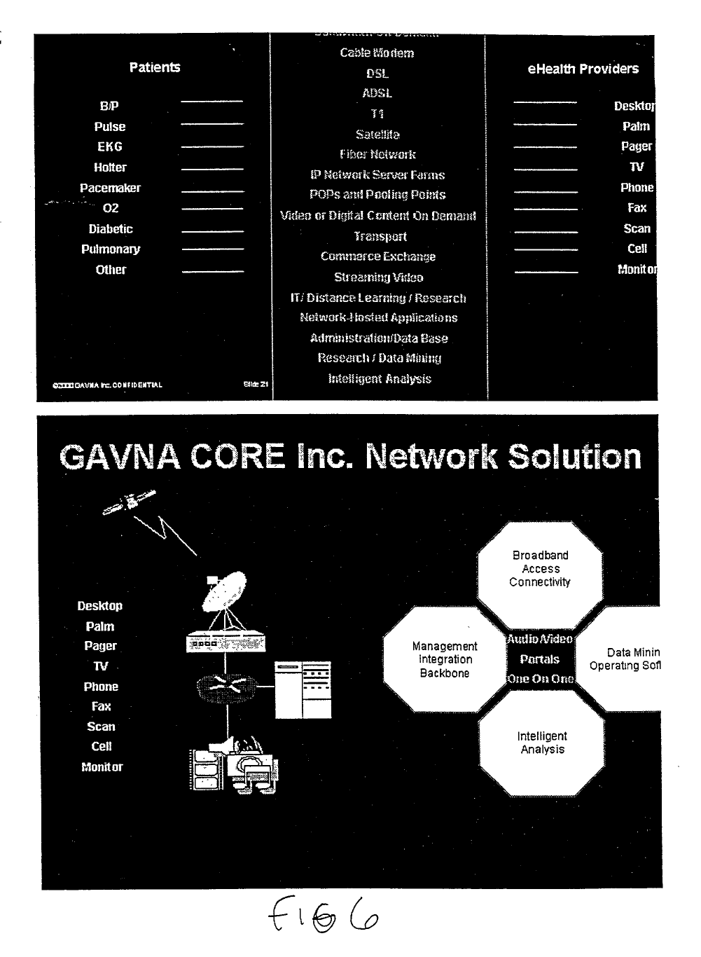

The invention facilitates centralized access to individuals, one on one, in an interactive visual and voice online, satellite, wireless integrated secure environment for the purpose of providing supervision in real time and on line examination with concurrent access to records, charts, test results, history, tests, research, data, billing mechanisms, data marts, medical images, correspondence, notes, files, vital signs, real time diagnostic testing results, images, consultation, pharmacology selection, detailing, alerts, transcription, conferencing, outcome data & research, reference and treatment options within a single screen/portal/channel. In a broader sense, referring to FIG. 6, the present invention, thus provides a comprehensive system including broadband access and connectivity, data mining and operating software, and a fully integrated backbone.

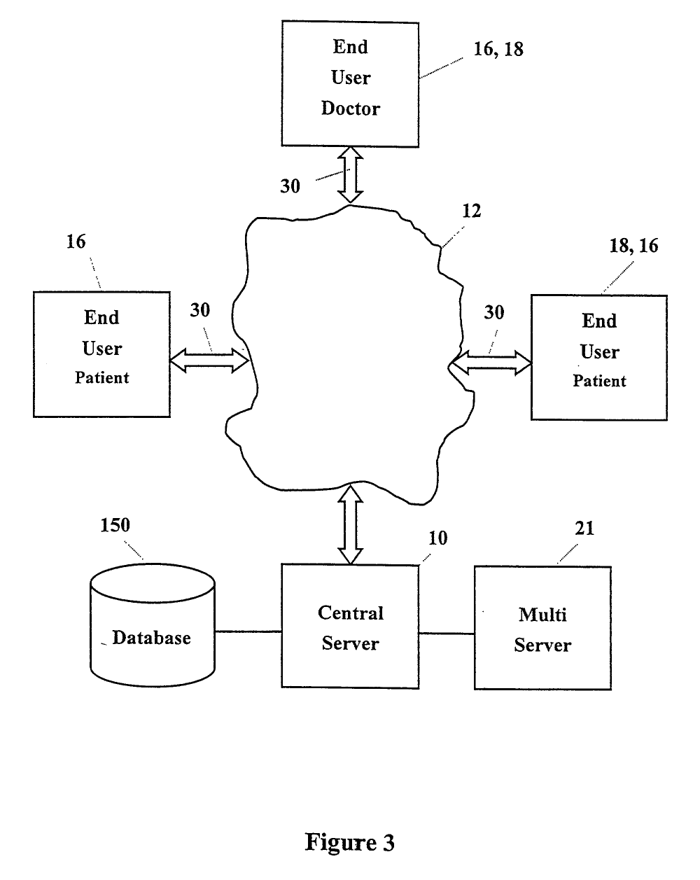

Referring to FIGS. 3 to 5, a more detailed embodiment of the present invention s disclosed and shown. As noted, the present invention in this embodiment is directed to an online system and technology whereby end users can engage in an exchange of online information such as health related information. In one embodiment, an audio/visual one-on-one real time monitoring and communication system. End users 16, 18, which may comprise a health care professional and patient need to share and access information.

From a structural and operational standpoint, the most preferred embodiment comprises a central computer server 10 connected by a computer network 12 to remote end user stations 14. The central server connects to a database 150. In a preferred embodiment, end user stations 14 comprise a plurality of end user healthcare providers 16 and patients (hereinafter collectively users) 18 linked via a transport medium 30. Preferable as noted, central server in one embodiment contributes a website such as www.uspreventivemed.com which will host a set of content and tools for the health and medical. As shown, the website will provide a host of database driven content related to health and wellness including multimedia presentations, FAQ, articles, chatrooms and bulletin boards. A critical feature is the provision of audio-visual interaction between the end users 16, 18 as well as diagnostic interaction.

End users 16, 18 as noted above, in a most preferred embodiment, will be linked via a global computer network 12 such as the Internet or worldwide web, but other embodiments including LANs, WANs and Intranets, fulfill the spirit and scope of the present invention. Both end user systems 16, 18 will typically comprise any device that connects to the system via the internet or other IP transport methods and includes, but is not limited to, such devices as televisions, computers, hand-held devices, cellular phones, land based telephones, wireless electronic devices and any device which uses a transport medium 30. Non-limiting examples of a transport medium 30 applicable for use in the present invention comprise any backbone or link such as an ATM link, FDDI link, satellite link, cable, cellular, twisted pair, fiber optic, broadcast wireless network, the internet, the worldwide web, local area network (LAN), wide area network (WAN), or any other kind of intranet environment such as a standard Ethernet link. In such alternative cases, the clients will communicate with the system using protocols appropriate to the network to which that client is attached. All such embodiments, necessary integration and equivalents thereof are intended to be within the scope of the present invention.

Referring again to FIG. 3, the present invention may comprise a multi-server 21 environment which comprises a computer system in accordance with the present invention that allows the multiple users 16, 18 to communicate with the system. Through communication link and transport medium 30, end users 16, 18 will be linked to the central server 10, preferably by a customizable interface to be described in greater detail below.

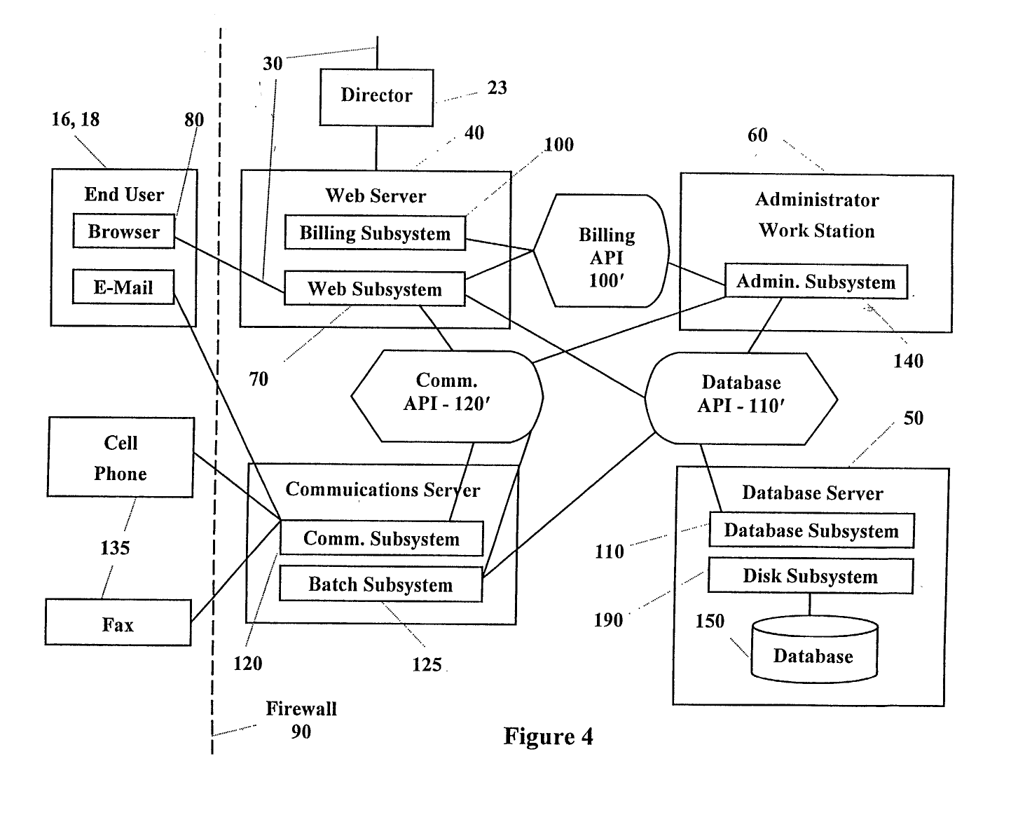

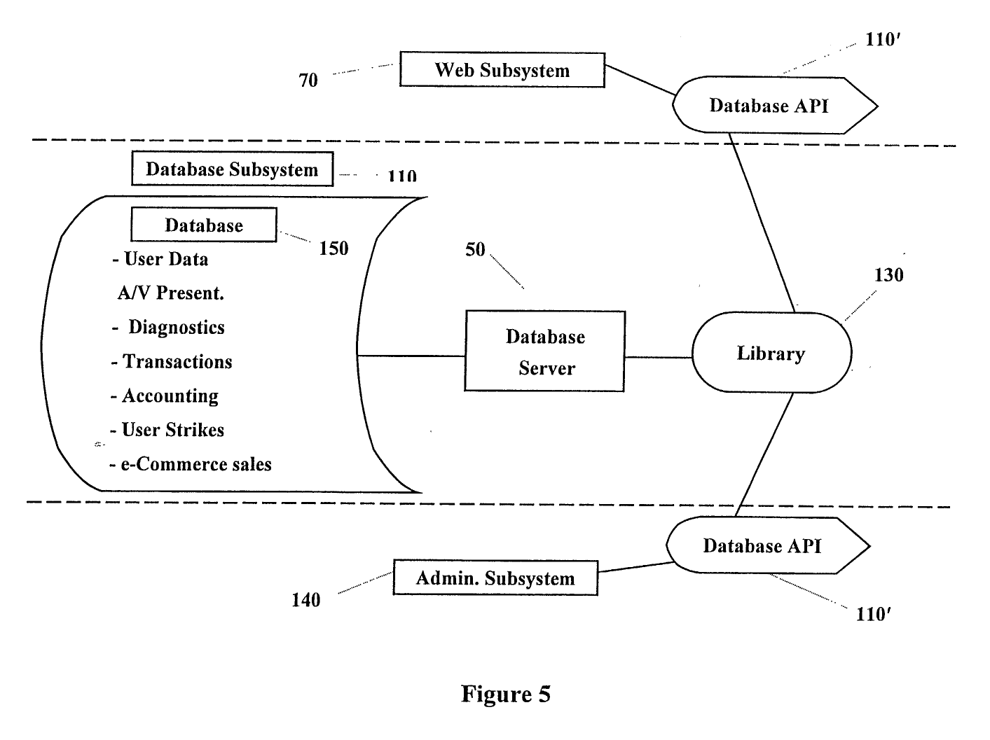

Referring to FIGS. 4 and 5, the central server and database systems of the present invention are now shown and described in greater detail. A local director 23 routes signals through the system to the various servers, to be described below, and to and through transport medium 30 to the end users 16, 18. The system preferably includes two primary servers, a web server 40 and a database server 50 which may operate using such database platforms as SQL server or Oracle. Hence, in one embodiment the SQL server may run SQL server database management software from Microsoft Corporation. Alternatively, the server can further comprise an Oracle database server. As noted above, the system also incorporates media servers.

The system further includes an administrative workstation 60 or system, which provides the administrative capabilities and monitoring for the system under the control of an administrative subsystem 140. The administrative workstation 60 allows administrators or other operators to perform routine operations, which affect the entire system. Such operations include, but are not limited to, administering the accounts of, for example, healthcare providers and patients, the ordering and control of products to be sold through the website, back end functions, adding or deleting new users, the tabulation of printing reports and performing of backups and maintaining the programs that comprise the overall system.

A web subsystem 70 is responsible for all interactions with a web browser 80 in the end user devices 16, 18 and serves as the end user interface to the system. All interactions between the devices 16, 18 and the database subsystem occur through the web subsystem 70. Internet Information Server 200 (IIS) by Microsoft Corporation is an exemplary web server software system 70 in accordance with the present invention, although the present invention is in no way limited to this system. The expression of the user interface presented to users 16, 18 in their client devices may be implemented as HTML or other high level computer language or technology, and may be displayed in a standard web browser including a wireless browser.

All systems listed above are preferably communicated via an Ethernet 100 base T network and a switching hub. In addition, a second isolated network segment will preferably exist between the web server 40 and the external communications hardware (e.g. internet router). Such a system will keep external traffic isolated from the internal network, as well as providing a dedicated connection between the web server 40 and the internet for maximum throughput. The systems will have an initial configuration of random access memory for the web server 40 and preferably at least 128 megabits for the database server 50, both having the capability to expand. The web server 40 is the point of entry to the entire system. The system determines the identity of the end users 16, 18 and makes appropriate decisions while serving web pages to the users 16, 18. The web server 40 sends HTML or other high level computer language to the end user work stations 16, 18, validates passwords, sends logging and transaction information to the database server 50, and performs logical operations, thus behaving as a transactional server.

As noted above, in one embodiment, the server operating system may be a Windows NT server, a multi-platform operating system provided by Microsoft Corporation and includes media servers. The Sun Microsystems Solaris is an alternative embodiment. The server typically includes IIS, which is a completely integrated internet application platform. IIS includes a high-performance web server, an application development environment, integrated full-text searching, multi-media streaming and site management tools. The security infrastructure is integrated within the server, thus enabling an easy-to-maintain and highly secure web development and deployment environment.

The operators of the system may create, delete and update account information by utilizing the administrative subsystem 140 in administrator work station 60. A billing subsystem 100 is responsible for credit card, debit card or checking account verification and any necessary billing type functions. Database 110, communication 120 and billing 100 subsystems thus execute essential services for the other parts of the system, and will therefore have well-defined application program interfaces (API) 110′, 120′, 100′, as is well recognized by those with skill in the art. The system will preferably be protected for the internet by a “firewall” 90 which is a safety precaution, and important with respect to the present invention due to the sensitive and confidential nature of some of the material in the database.

In a preferred embodiment, the database subsystem 110 stores all pertinent information pertaining to end users 16, 18, transactions, and account history as well as general dynamic system information. All interactions with the database subsystem 110 are performed through a database API 110′ which may define the interface to a library of stored procedures 130. These are used to implement high-level database functions and to shield the details of the database implementation from the other subsystems. The database subsystem 110 is preferably implemented using database server 50. The database contains such information as user information, records, account status, the inventory of items available for sale, content, multimedia presentations and medical histories.

The administration subsystem 140 provides an interface for operators and managers of the system to modify the database, print reports, view system data and log user information. The administration subsystem 140 provides a collection of access forms, queries, reports and modules to implement the administration interface. Administrators typically will have the power within the system to force most actions. The administration subsystem 140 will interact with the communications, database and billing subsystems.

The communications subsystem 120 is interfaced to a communications API 120′ will be used to notify end users 16, 18. Users 16, 18 may be notified by phone, fax, email or pager, or other communications devices, which can be contacted by the system 135. Some portable telephones and pagers include email addresses and so may be contacted by the email system; other users have only phone numbers. Other interfaces may be utilized as the application so demands.

A batch subsystem 125 may periodically send out grouped notifications. It will access the database subsystem 110 to determine what notifications are required, and uses the communication subsystem 120 to make those notifications. The billing subsystem 100 may be used to verify and bill credit cards, where applicable, and communicate through the billing API 100′ to the administration subsystem 140, and potentially to an outside billing and verification service which could be used to perform the billing functions.

Referring to FIG. 5, the database server 50 which implements the database subsystem 110 of the present invention comprises a server that maintains all associated logging and transaction information for the system. Through the database 150 (which is backed up by a backup database for safety purposes), the database server 50 logs user setup, account creation information, diagnostic information and tests, maintains and tabulates transactions and collections, hosts backup operations and performs statistical calculations for the entire system.

The database server 50 is preferably a dual processor computer microprocessor. Each connection to the database 150 and its associated work may be handled by a separate thread within the database server 50 processor space. It is anticipated that a dual processor machine is sufficient for the type and amount of transactions that it will be performing, however if it proves insufficient, the database can be “striped” to two or more machines to distribute the server load.

The disk subsystem 190 of the database server may comprise a vulnerable and crucial server element. Due to the mission critical design of the subsystem, it is preferable to utilize a Level 5 RAID. RAID is an alternative to standard SCSI hard disk drives. A RAID system provides automatic recovery from hard drive failures. Level 5 RAID systems provide the best balance between cost and level of data protection. A Level 5 RAID system uses multiple hard disk drives, on which the stored data is recorded redundantly using a scheme by which the data on the disk can be reconstructed if one of the disk drive units in the RAID fails. In the event of failure, the failed drive can be removed from the RAID system while it is still operating, and a replacement drive can be installed. The RAID system will regenerate the data and return itself to full protection capability. The data sorted on the disk subsystem remains available for normal processing, that is, from the time the drive fails to the time the RAID system is returned to full protection capability. Other levels of RAID which are less costly do not offer this type of data availability and could translate into costly system downtime.

Statistical calculations will be performed by the database server 50, along with other types of report generation. Specifically, IIS can log directly to an Open Database Connectivity (ODBC) standard data source. This makes the availability of the data collected by the database server about client activity on the system more readily available and easier to process into logical reports. Preferably the database server system is configured with a dual P6 CPU, 128 MB ECC, having sufficient ECC RAM, a graphics adapter capable of showing 1024×768 pixels with a depth of 8 bits, a 21 inch monitor, a PCI Fast/Wide SCSI-2 I/O adapter, one PCI 100base T Ethernet adapter, a keyboard and a mouse, a 3.5 inch floppy drive, a CD ROM Drive, a disk drive, a 2 GB PCI Fast/Wide SCSI-2 hard disk drive, two 9 GB PCI Fast/Wide SCSI hard drives (Level 1) or an 8 GB RAID Subsystem (Level 5), and a 24 GB DAT SCSI (2 MB per minute) tape back-up unit.

In one embodiment, there will be one operator workstation 60 used for administering the system. As the need for additional workstations arises, additional operator workstations can be added by adding additional computer systems, installing the administration software and connecting them to the LAN. Operator workstation machines preferably utilize a Windows operating environment manufactured by Microsoft Corporation.

In view of the above operational environment, the present invention is now described in the context of a web-based system for providing online, interactive content between two end users 16, 18. In one embodiment, the end users comprise a doctor and patient. In other embodiments, the end users can comprise an attorney-client, real estate broker-customer, or any other pair of commercial users who need to provide content and information to each other.

By utilizing the system end user 16,18 is able to quickly locate information on a desired basis. The present invention has a number of uses and applications, including the ability to “push” updated information to end users; to send e-mail notices, to enable users to continue to use the “programs” available from the site when “offline”; to provide content and audio video formats; to enable end users to track their own progress when using program; to receive dynamic risk assessments and to locate health-care services and providers. The system incorporates data storage and security for medically sensitive information.

Other applications are suggested by the present invention. Both federal and state prisoners are required to have medical and psychiatric care. This could be provided by the present invention. Similarly the care of military veterans could be undertaken with the present invention, thereby realizing significant cost savings from information. The present invention could be used in the areas of rural or remote psychoanalysis. Some emergency services could also be provided in a one on one supervision environment in advance of transport or facility treatment. Post surgical monitoring in modern nursing homes is another application. Emergencies in nursing homes, monitoring and medical care could be provided by the present invention.

As shown in FIG. 6, the present invention thus provides a comprehensive system including one on one real time audio visual supervision, broadband access and connectivity, data mining and operating software, and a fully integrated backbone.

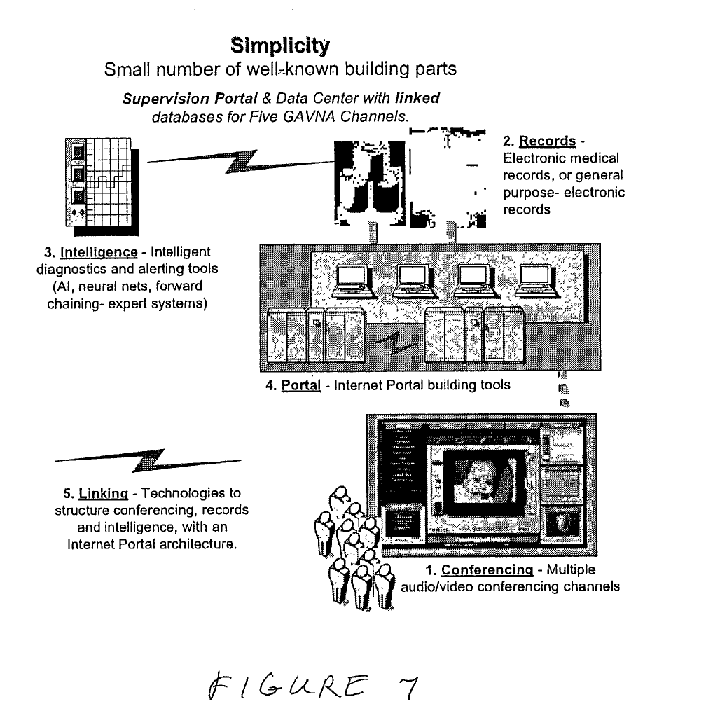

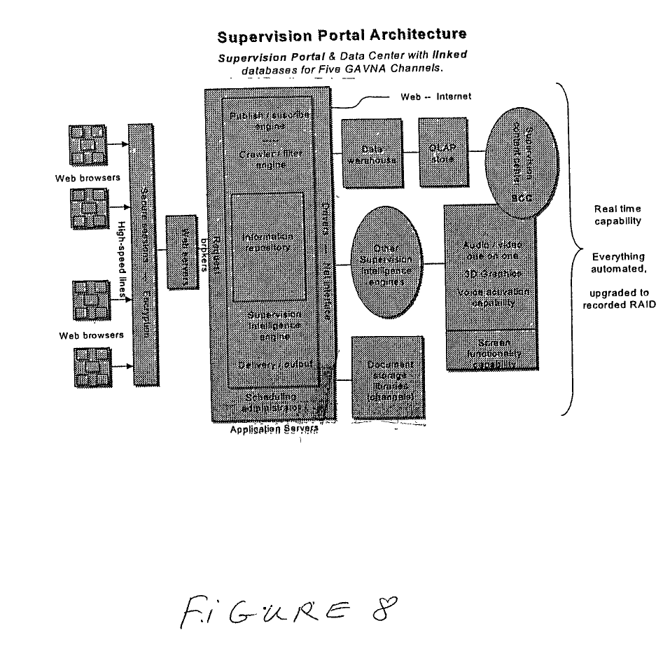

In a further embodiment as shown in FIGS. 7 and 8, the invention provides full time supervision through audio/video contact, for children, elderly, or sick people, where the audio/video is turned into a direct, diagnostics tool, drastically enhancing intelligence gathering during supervision.

As shown in FIG. 7, tt is to be noted that the invention provides for multiple channel supervision environments. In one embodiment, five different information streams (audio/video or virtual electronic records channels) are simultaneously available to the physician during supervision procedures. The invention provides for selectability of audio video channels 200, in response to patient, user, institutional addresses, who accesses concurrently records, charts, history, etc. A faster channel provides supervision and contains the audio/video streams necessary for live one-on-one supervision activities, such as those involved in telemedicine applications.

The second channel 202 provides records and contains personal information of the patient (electronic medical records, EMRs) such as charts, doctors' notes, portion of audio/video sessions, etc. The third channel, channel 3 204, provides diagnostics and, refers to specific real-time alert signals generated from tests run on medical instrumentation results, compared to records information and audio/visual streams. Channel 4, 206 provides “E-health” or “Treatment”, and automatically generates prescriptions and presents them to the doctor for review and addition of his electronic signature. It also interfaces with pharmacies, and allows patients access to information about their treatments via a portal.

Finally, a fifth channel 208, Channel 5 comprises, the administrative and other management functions needed for each application, such as patient billing and insurance filing and purchasing. Purchasing is another feature of the administrative channel, where inventories are matched to patients needs, and orders are automatically generated when necessary. Interfaces with hospital administrative systems will be transparent to the user.

It is to be noted that that the administrative channel scenario involves prescribing as a service. A Palm-like or hand-held device may support a cellular phone and WLAN connections to the system and the patient. In an example, a doctor may write a prescription. The system will automatically send it for pre-authorization to his insurance company. The patient will pay his normal co-payment to the insurance company. The “Palm” like device may be used by the doctor's stuff to update the patient's electronic medical records in real time.

The invention opens up structured intelligence gathering from unstructured multichannel audio/video streams. The invention is characterized by a number of features including multiple audio/video conferencing channels; records—Electronic medical records, or general purpose-electronic records; the use of intelligent diagnostics and alerting tools; and incorporation of a portal which links tools and embeds technologies.

The invention provides the means to interpret audio/video information, thus opening up an unlimited number of applications. The invention builds intelligence from basic and massive information gathering, and allows constant audio/video, the simultaneous operation of store-forward and real time audio/video in a single channel, and the progressive resolution control for selected elements in the audio/video stream, all in limited bandwidth systems

The invention provides for the full-time supervision of children, the elderly and those requiring medical treatment and monitoring for security purposes, medical purposes, insurance purposes, etc. The invention incorporates medical instrumentation, survey and sensing equipment, and measuring instrumentation of different types, supplemented with audio/video readings. It provides for 3-D visualization or wear-on pieces (bracelets, rings, helmet) for a/v supervision of patients. Voice-to-text translation and voice commands for the creation of time marks in the continuous supervision audio/video stream.

The system can monitor the ingestion of digestible solids or liquids for internal measurements and facilitates the attachment of measuring instruments to the body of the supervised individual (be it living organisms, a machine, or a non-living entity. It further facilitates temperature and infrared visual and tomography measurements.

A critical feature of the invention is the incorporation of multi-channel intelligence and diagnostics with an intelligence engine, neural net matching and forward-chaining expert systems. In this way the invention is applicable or can link to multiple Industries and applications: treatment programs, guidelines, notes, orders, protocols, images, diagnostic data, consult sources, research information, outcomes, pharmacology data-inserts, contraindications-clinical history, studies, papers, news clinical data in geriatric, chronic, fitness, wellness, radiology, cardiology, psychology, human resource interview, training, educational, prisons, hospitals, clinics, treatment centers, elder care facilities, nursing facilities, rural tele-health, health, teleconferencing, live examination, assessment, diagnosis, treatment program applications.

All the above translate to the following three-stage functionality: (1) Information, that is the pervasiveness of information, through multichannel availability, and gradual implementation of technologies capable of extracting and structuring information from multiple non-structured audio/video data streams; (2) analysis of data and information by the healthcare professional; and (3) response, through hyper annotation and linking between audio/video data and structured database records information and through real time response through diagnosis and alerting features.

Particular business implementations may follow architectural models such as the following: various telemedicine and videoconferencing implementations; and Internet corporate portal architectures.

Referring now specifically to FIG. 8, the invention may be implemented as a portal for secure, real-time interaction supervision. This Core Supervision Portal involves all the key elements considered in the definition of an Internet Portal, providing the functionality to support users' needs.

The ideal technical architecture is one where the following elements are considered as services and can be integrated together in a comprehensive distributed object architecture: The integration of information to feed the individual's desktop. The preferred portal filters the information to meet the individual's work style and content preferences, ranging from the look of the desktop to what is displayed where, to filtering and profiling capabilities. It further provides profiling to enable the user to continuously update his or her profile based on current interest so that relevant information can be retrieved on an on-going basis.

The preferred portal will permit collaboration, or project style working forums for interactions among patients, doctors, suppliers, employees, customers, partners, etc., with groupware functionality permitting calendaring, project contributions, project management, work scheduling, chat, etc. It will enable participation in electronic processes through the interaction of workflow at different entry and exit points. It will also enable the publication and distribution of content creation, inclusion and distribution, thus approving what is made available to the portal through workflow processes. It will include a search function. It will also provide calendaring and event based reminders, triggered by events to help manage increasing workloads, responsibilities and control processes. Finally, it will allow administration, that is, administering and management of the portal environment, from managing users right through, and ensuring the portal meets acceptable performance criteria, to time-based usage billing.

The system will include substantial document storage libraries (channels) architecture storing supervision data, such as, for health-related applications, integration of existing hospital, insurance, HMO, industry, government, image delivery, storage, mega data and software data systems in a common data archive.

In operation, users accessing the service will utilize web browsers such as Microsoft's Internet Explorer or Time Warner-AOL's Netscape Navigator. High-speed lines are desirable but not necessary. The system will use encryption, thus offering secure sessions for patient confidentiality. Application servers host the Information, repository and the publish/subscribe engine, crawler/filter engine, supervision intelligence engine (hereforth abbreviated as SI). The service offers filtered and managed access to information contained in the Internet, plus proprietary data warehouses and the Supervision Content Center (SCC). A Supervision Intelligence engines offer several of the unique facilities provided such as audio/video one-on-one, 3D visualization graphics, voice activation capability, and particular screen functionality features. Document storage libraries gather information specific to the five GAVNA channels discussed above.

In substance then, the invention comprises a plurality of internet portal building tools which link to embedded, intelligent diagnostics and alerting tools (AI, neural nets, forward chaining-expert systems); and technologies to structure conferencing, records and intelligence, within an Internet portal architecture.

This includes multiple audio/video conferencing channels for applications such as telemedicine; one-on-one, collaborative, multi-channel application supporting transport of audio/video, with: Multiple audio/video and content frame windows; interactive live audio/video communication and one-on-one supervision, based on industry standards; combining store & forward tags with real-time audio/video, containing information corresponding to live motion and still images; medical instrumentation support Integrating medical digital examination and vital signs from selected devices in real time, and with storage capability; and access to stored information:

The health care provider will have single screen access to patients/subjects while combining evaluations, monitoring virtual medical records (VMRs), diagnostic tools, pharmacology, research, statistical outcome analysis, treatment protocols, history and options, medical test results, e-commerce and content.

This information may be structured as follows: Store-and-forward for structured (XML), grid (spreadsheet) or record (database)-based presentation of data, comprehending quantitative, text based, or static image information. Store-and-forward audio and video. Real time audio and video (low latency, high QoS threshold based on existing and future Internet2 standards).

For example, for health-industry applications, electronic medical records are the basic structure of the invention's information, storing the patient's medical history, current treatments, medications, insurance, the results of patient visits (including laboratory test results, the physician's diagnosis, medications prescribed and treatments administered), the patient's billing, and payment and scheduling records. Intelligence Intelligent diagnostics and alerting tools (AI, neural nets, forward chaining-expert systems).

Abundance of information in a multi-channel environment requires real-time response requires intelligent aids such as an alerting tool. This alerting tool for real time patient monitoring is based on knowledge systems comprising sickness-symptom lists with quickly variable levels of responsiveness through fuzzy logic.

Medical annotations will be coded. Annotations may be voice activated, then recorded, converted to text and finally converted to a compressed symbolic representation particularly suitable to immediate analysis for medical

The core portal of the present invention may be described based on a merger of Web-Conferencing and the Web-based ASP GroupWare models: The invention allows patients and doctors to work together as a group, their main goal being the patient's health, sharing information contained in selected EMRs, and even storing selected excerpts from audio/video interaction in those EMRs. This is indeed a full GroupWare system application. The invention thus brings standardization to the medical industry, thus pulling together currently separate efforts by leading corporations, and finally generating momentum.

Three attributes, already described above, are key to achieve these goals:

1. Completeness—Pervasiveness of information, through multichannel audio/video availability

2. Structure—Structure allowing analysis and response, through hyper annotation and linking between channels

3. Real time—Real time response on that structure, through diagnosis and features.

The present invention has been described with reference to the enclosed Figures ailed description. It is to be appreciated that the true spirit and scope of the on is to be determined with reference to the attached claims.

1. A method for providing an end user with the information relevant to an area of interest comprising the following steps:
(a) providing a web based channeled network site or sites comprising a presentation whereby the initiator and/or end user can select various options related to the area of interest;
(b) providing an interface whereby the end user can directly interface in real time with a professional end user; and
(c) facilitating the payment by the end user for a service to be provided by the professional end user.

2. The method of claim 1 wherein the end user can access a multimedia presentation related to the area of interest.

3. The method of claim 1 where a condition of the end user can be monitored by the professional end user.

4. A method for providing an end user with the information relevant to an area of interest comprising the following steps:
(a) providing a web based channeled network site or sites comprising a presentation whereby the initiator and/or end user can select various options related to the area of interest and engage in one on on real time communication;
(b) providing an interface whereby the end user can directly interface in real time with a professional end user; and
(c) facilitating the payment by the end user for a service to be provided by the professional end user.
